(19) United States
(12) Patent Application Publication
(10) Pub. No.: US 2008/0007616 A1
(43) Pub. Date: Jan. 10, 2008

(54) Universal multimedia display adapter

(75) Inventor: Pachyappa Baladhandayuthapani, Singapore (SG)

Correspondence Address: STEPHEN B. ACKERMAN, 28 DAVIS AVENUE, POUGHKEEPSIE, NY, 12603, US

(73) Assignee: FTD Technology Pte. Ltd.

(21) Appl. No.: 11/005,172

(22) Filed: Dec. 6, 2004

(51) Int. Cl. H04N 7/14

(52) U.S. Cl. 348/14.12

(57) ABSTRACT

An interface adapter converts a video signal compliant with multiple video transmission interface specifications to a video signal compliant with a HDMI specification for display upon a video display. The interface adapter has a plurality of input ports to receive the video signals. The interface adapter further has a source selector to select one of the input ports to provide the video signal. A synchronization device receives and retains the selected video signal based on timing signals of video signal's transmission interface specification. A high definition multimedia formatter extracts the video signal with a timing signal in compliance with the HDMI specification, formats the video signal to the voltage levels and format of the HDMI. A transition minimized differential signaling driver amplifies and buffers the video signal in compliance with the HDMI specification for transfer through the output port to a video display.

### BACKGROUND OF THE INVENTION

1. Field of the Invention

This invention relates generally to electronic apparatus, circuits, and methods for converting levels and protocols of video signals from video source devices that comply with one of a group of video transmission interface specifications to the signal levels and protocols of a high definition multimedia interface (HDMI) for transmission to a video display.

2. Description of Related Art

Current multimedia television monitors such as cathode ray tube, liquid crystal displays, and plasma display are capable of accepting the radio frequency television signals from the atmosphere or from cable distribution systems. Additionally, the multimedia monitors may receive “baseband” red, green, and blue composite video signals with the audio from video sources such as video cassette recorder, digital video disk (DVD) players or video camera recorders (camcorder) for display. Referring to FIG. 1, the video player 5 and the video camcorder 10 transmit the baseband 25 red, green, and blue composite video signals with the audio to the multimedia display unit 15 for presentation. The video camcorder 10 may also provide signals that comply with the IEEE 1394 high performance serial bus peer-to-peer data transfer protocol specification or the universal serial bus (USB) specification. These video signals from the camcorder 10 must then be transferred to another device such as a personal computer (not shown) for conversion to the red, green, and blue composite video signals for transfer to the multimedia display unit 15.

As digital television and high definition television is becoming more available, the new digital video disk players 20 and similar equipment provide output ports that comply with the digital visual interface (DVI) 30 specification as promulgated by the Digital Display Working Group. The multimedia display unit 15 receives the DVI and audio signals 30 for display.

As commercial and cable television has migrated to high definition digital transmission, equipment manufacturers have cooperated to create the specification for the High-Definition Multimedia Interface (HDMI) to describe transmitting digital television audiovisual signals from DVD players, cable television set-top boxes and other audiovisual sources to television sets, projectors and other video displays. HDMI can carry high quality multi-channel audio data and can carry all standard and high-definition consumer electronics video formats. Further, HDMI can also carry control and status information in both directions.

Referring to FIG. 2, HDMI system architecture is defined to consist of Sources 35 and Sinks 40. The HDMI source device 35 communicates with the over HDMI cable and connectors. The HDMI cable and connectors carry four differential pairs that make up the Transition Minimized Differential Signaling (TMDS) data and clock channels 45a, 45b, 45c, and 45d. These channels 45a, 45b, 45c, and 45d are used to carry video, audio and auxiliary data. In addition, HDMI cables and connectors carry a digital data (DDC) channel 50. The DDC 50 is used for configuration and status exchange between a single Source 35 and a single Sink 40. The optional Consumer Electronic Control (CEC) line 55 provides high-level control functions between all of the various audiovisual products in a user's environment.

Video 75, audio 80 and auxiliary data is transmitted across the three TMDS data channels 45a, 45b, and 45c. The video pixel clock is transmitted on the TMDS clock channel 45d and is used by the receiver 60 as a frequency reference for data recovery on the three TMDS data channels 45a, 45b, and 45c. Video data is carried as a series of 24-bit pixels on the three TMDS data channels 45a, 45b, and 45c. TMDS encoding converts the 8 bits per channel into the 10 bit DC-balanced, transition minimized sequence which is then transferred by the transmitter 65 serially across the pair at a rate of 10 bits per pixel clock period.

Video pixel rates can range from 25 MHz to 165 MHz. Video formats with rates below 25 MHz (e.g. 13.5 MHz for NTSC) can be transmitted using a pixel-repetition scheme. Up to 24 bits per pixel are transferred. In order to transmit audio and auxiliary data across the TMDS channels 45a, 45b, and 45c, HDMI uses a packet structure. In order to attain the higher reliability required of audio and control data, the data is protected with an error correction code and is encoded using a special error reduction coding to produce the 10-bit word that is transmitted.

The DDC 50 is used by the Source 35 to read the Sink's Enhanced Extended Display Identification Data (EDID) from the EDID read only memory 70 in order to discover the Sink's configuration and/or capabilities.

The audio and video is generally a DVI compliant digital video with digital audio such as an MP3 coded audio files or composite analog video with analog audio as transmitted in a base band television signal. Other sources of video such as from a camcorder or an older video recorder must have an adapter to comply with the HDMI specification. The receiver 60 then converts the TMDS data signals 45a, 45b, and 45c formatted to the HDMI specification to video and audio for the multimedia display unit 15.

U.S. Patent Application 2002/0005863 (Nagai et al.) describes an image-transmitting-side device. The device has a one-phase to two-phase converter circuit for separating transmitted parallel image data into even and odd data. Two parallel-serial converting circuits convert the parallel even and odd data to two serial streams. A device allows a user to select the resolution mode for the image data to be transmitted. A switch applies the transmitted parallel image data to one of the parallel-serial converting circuits upon selection of the first resolution mode. The switch applies the transmitted parallel image data the one-phase to two-phase converter circuit when the second resolution mode is selected.

U.S. Patent Application 2002/0049879 (Eyer) provides a cable and connection with integrated DVI and IEEE 1394-2000 capabilities. The cable is utilized to transmit DVI signals and IEEE 1394-2000 signals over a single cable. A standard DVI cable and a DVI connector are used to integrate a DVI interface with an IEEE 1394-2000 interface. In the preferred embodiment, DVI data is transmitted over the first TMDS link, including channels 0-2, and IEEE 1394-2000 data is transmitted over two twisted pairs within the second TMDS link, including channels 3-5. Preferably, a DVI connector routes the DVI signals to or from the DVI digital signal lines corresponding to the first TMDS link to a DVI receiver circuit or a DVI transmitter circuit, as appropriate, and routes IEEE 1394-2000 signals to or from the DVI digital signal lines corresponding to the second TMDS link to an IEEE 1394-2000 interface circuit. Each connector at either end of the DVI cable then is in communication with either a DVI transmitter circuit or a DVI receiver circuit, as appropriate, to communicate the DVI video signals, and also with an IEEE 1394-2000 physical interface circuit to communicate the IEEE 1394-2000 signals.

U.S. Pat. No. 6,600,747 (Sauber) describes a video monitor multiplexing circuit. The signal selects one a group of signal interfaces from a computer system to either an analog display or a digital display. The video signals that are in digital format and in analog format are supplied to a circuit that multiplexes the digital signal and the analog signal. The circuits generate an appropriate analog or digital output signal for the display.

U.S. Pat. No. 6,535,217 (Chih, et al.) teaches an integrated circuit for graphics processing that includes a configurable display interface. The circuit includes video graphics circuitry, a data encoder, transmission circuitry and configuration registers. The video graphics circuitry produces video data that is formatted to drive a display. The data encoder is operably coupled to the video graphics circuitry and encodes the digital video data to produce transmission data. The transmission data is then provided to the transmission circuitry operably coupled to the data encoder. The transmission circuitry combines the transmission data with control information that is retrieved from registers included in the integrated circuit. The transmission circuitry transmits the transmission data over a plurality of differential signals, where the swing amplitude of the differential signals is configured using additional registers included in the integrated circuit.

U.S. Pat. No. 6,345,330 (Chu) details a communication channel and interface devices for bridging computer interface buses. The device bridges a first computer interface bus and a second computer interface bus. Each of the first and second computer interface buses have a number of parallel multiplexed address/data bus lines and operate at a clock speed in a predetermined clock speed range having a minimum clock speed and a maximum clock speed.

U.S. Pat. No. 6,216,185 (Chu) describes a personal computer system that has physically separate units and an interconnection between the units. An attached computing module (ACM) contains the core computing power and environment for a computer user. A peripheral console (PCON) contains the power supply and primary input and output devices for the computer system. To form an operational computer system, an ACM is coupled with a PCON. The plug-in module design of the ACM, and the concentration of high-value components therein (both in terms of high-value hardware and high-value files), makes it easy for a user to transport the high-value core between multiple PCON's, each of which can enjoy a relatively low cost. The concentration of a user's core computing environment in a small, portable package also makes it possible for large organizations to perform moves, adds, and changes to personal computer systems with greater efficiency.

### SUMMARY OF THE INVENTION

An object of this invention is to provide an interface adapter to convert a video signal having signal levels and format compliant with one of a plurality of video transmission interface specifications to a video signal compliant with a high definition multimedia interface for display upon a video display.

To accomplish at least this object, the interface adapter has a plurality of input ports in communication with source devices whereby one source device is selected to provide the video signal. Each of the input ports accepts video signals that comply with one of the plurality of video transmission interface specifications. The interface adapter further has a source selector in communication with the input ports to select one of the input ports to provide the video signal from a desired source device.

A synchronization device is in communication with the plurality of input ports for receiving and retaining the video signal based on timing signals in compliance with the video transmission interface specification to which the video signal conforms.

A high definition multimedia formatter is in communication with the synchronization device to extract the video signal with a timing signal in compliance with the high definition multimedia interface specification, format the video signal to the voltage levels and format of the high definition multimedia interface. The interface adapter further includes a transition minimized differential signaling driver in communication high definition multimedia formatter to amplify and buffer the video signal in compliance with the high definition multimedia specification for transfer to the output port. The output port transmits the video signal in compliance with the high definition multimedia specification to a video display.

The interface adapter includes an analog input port in communication with analog video sources to accept an analog video signal. An analog to digital converter is in communication with the analog input port to receive the analog video signal and converts the analog video signal to a digital video signal. The analog to digital converter is in communication with the high definition multimedia formatter to format the digitized analog video signal to the voltage levels and format of the high definition multimedia interface.

The interface adapter also has a digital video interface port in communication with a digital video interface video source to receive a digital video interface video signal for transfer to the source selector for optional selection for transfer to the output for transmission to the video display. The interface adapter additionally has a high definition multimedia interface input port in communication with a high definition multimedia interface video source to receive a high definition multimedia interface video signal for transfer to the source selector for optional selection for transfer to the output for transmission to the video display.

The plurality of video transmission interface specifications comprises a peripheral component interconnect specification, a universal serial bus specification, a personal computer memory card specification, an advanced attachment specification, a flash memory card specification, and high performance serial bus peer-to-peer data transfer protocol specification.

### BRIEF DESCRIPTION OF THE DRAWINGS

FIG. 1 is a block diagram of a multimedia audio/visual system of the prior art.

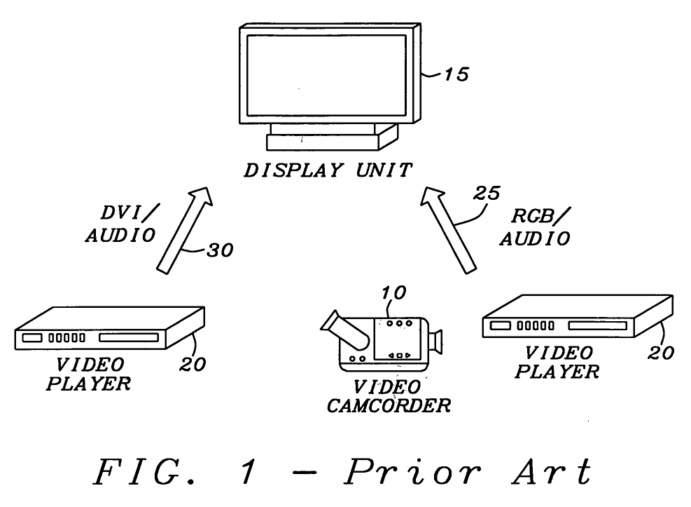

FIG. 2 is a functional block diagram of the High Definition Multimedia Interface (HDMI) architecture of the prior art.

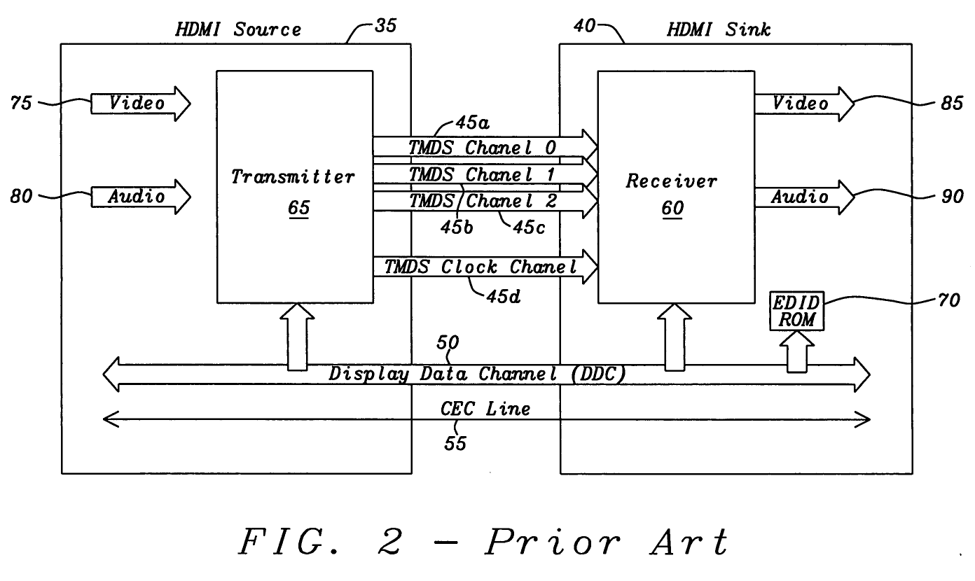

FIG. 3 is block diagram of a multimedia audio/visual system of this invention.

FIG. 4 is block diagram of the display adapter of this invention.

FIG. 5 is a block diagram of the High Definition Multimedia Interface (HDMI) of this invention.

### DETAILED DESCRIPTION OF THE INVENTION

The audio/visual interface adapter of this invention includes input ports each of which accepts multiple video signals from video sources having signal levels and formats compliant with one of a plurality of video transmission interface specifications. One of the input ports is selected to provide a video and then convert the video signal to a video signal compliant with HDMI for display upon a video display. The adapter acquires the selected video signal and the places in a synchronization device at with timing signals in keeping with the selected video source. The audio/visual interface adapter then retrieves the video signals from the synchronization adapter with timing signals that comply with the clocking rates of the HDMI specification. The adapter then formats the video signals to comply with the HDMI specification for transmission to the video display.

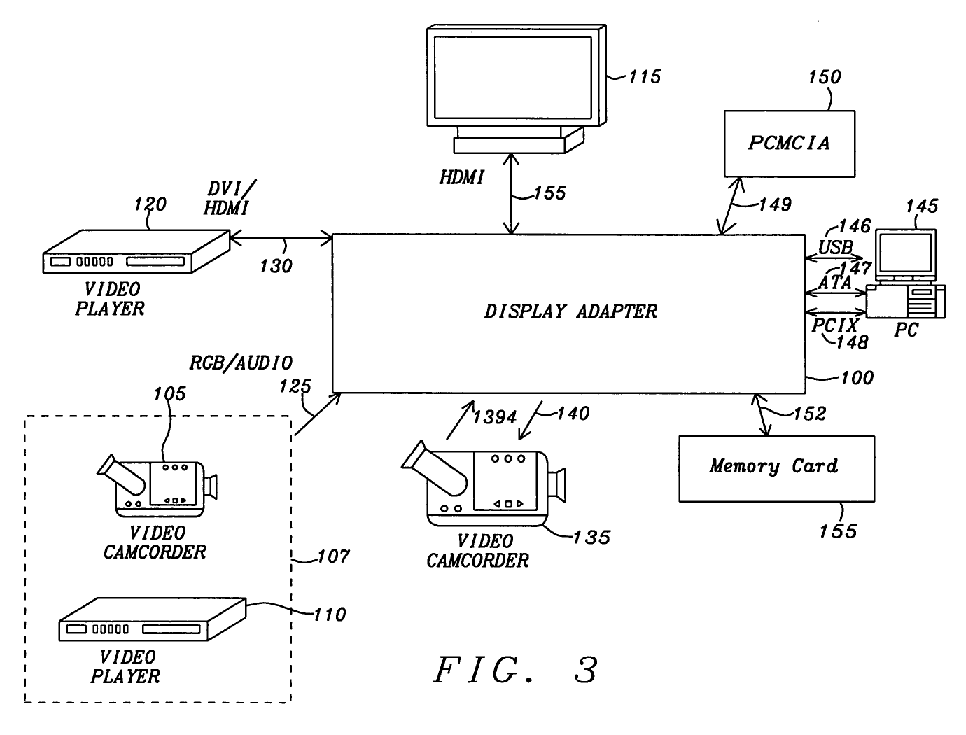

Refer now to FIG. 3 for a more detailed discussion of the audio/visual interface adapter of this invention. The audio/visual interface adapter 100 has input ports that receive video signals from a personal computer 145. The types of the video signals transferred from the personal computer 145 are those formatted to comply with the universal serial bus specification (USB) 146, advanced attachment specification (ATA) 147, the peripheral component interconnect specification (PCIX) 148. The video signal may also transferred from a personal computer memory card specification (PCMCIA) adapter card 150 on a PCMCIA bus or from a flash memory card 155 one the memory card bus 152. Examples of the flash memory card is the XD-Picture card™ from Olympus Optical Co., Tokyo Japan, the SD card and Smart Media Card from SanDisk, Inc., Sunnyvale, Calif., and the Memory Stick® media adapter from Sony Electronics, Inc., San Diego Calif. Another video source is a camcorder 135 that has incorporates a bus 140 that adheres to an IEEE 1394 specified high performance serial bus peer-to-peer data transfer protocol.

The audio/visual interface adapter 100 has an input port that accepts a connection 125 that transmits the red, green, blue composite video and audio from a source such as the video camcorder 105 and the video tape or disk player 110. A video player such as a DVD player 120 is connected through the DVI or HDMI interface 130 to the input port of the audio/visual interface adapter 100.

The audio/visual interface adapter 100 has an output port that connects to an HDMI connector and cable 155 to transmit the HDMI formatted video signal to the video display 115.

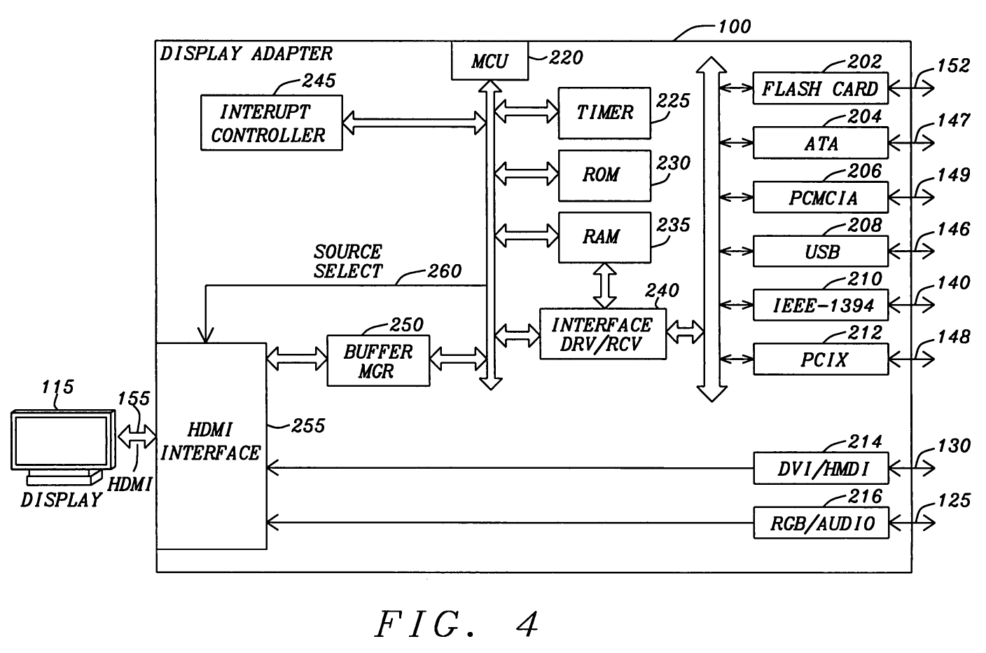

Refer now to FIG. 4 for a description of the structure and function of the HDMI display adapter 100 of this invention. The HDMI display adapter 100 has a PCIX input port 212 that receive video signals from the PCIX bus 148, a USB input port 208 connected to the USB bus 146, the ATA input port 204 connected to the ATA bus 147, a PCMICIA adapter connected to the PCMCIA bus 149, a flash memory card adapter connected to the memory card bus 152, and an IEEE 1394 adapter connected to the bus 140 that adheres to an IEEE 1394 specified high performance serial bus peer-to-peer data transfer protocol.

The above input ports 202, . . . , 212 are connected to the interface driver/receiver circuit 240 that converts the signal levels of the above input ports 202, . . . , 212 to the levels acceptable by the display adapter micro control unit 220. The micro control unit 220 has associated a read only memory 230 containing necessary program process coding and a random access memory 235 for providing data storage space for the received video data from the above input ports 202, . . . , 212. The timer circuit 225 provides the necessary clocking signals for the appropriate extraction of the video data signals from the video signals received on the above input ports 202, . . . , 212. The interrupt controller 245 receives interrupt signals for controlling the flow of the video signals through the display adapter 100.

Upon determining the desired source from the above input ports 202, . . . , 212, the micro control unit 220 instructs the interface driver/receiver circuit 240 to acquire the video signal from the selected input port 202, . . . , 212. The video data is then transferred to the buffer manager 250. The video data is stored in the buffer manager 250 under the control of a timing signal that complies with specification of the selected input port 202, . . . , 212.

The video data is then transferred to the HDMI formatter 255 employing a timing signal that complies with the HDMI specification. The HDMI interface 255 then formats the selected video signal to comply with the HDMI specification and transmits the HDMI formatted video signal on the HDMI connector and cable 155 to the video display 115

The HDMI interface adapter 100 further has an input port 216 that accepts a connection 125 that transmits the red, green, blue composite video and audio and a DVI/HDMI input port 214 connected DVI or HDMI interface 130. The red, green, blue composite video and audio signals from the input port 216 and the DVI or HDMI compliant signals from the input port 214 are transferred to the HDMI interface. The source select signal 260 is activated to indicate which of the video data signals is to be converted to the HDMI compliant video signals for transmission on the connector and cable 155 to the video display 115.

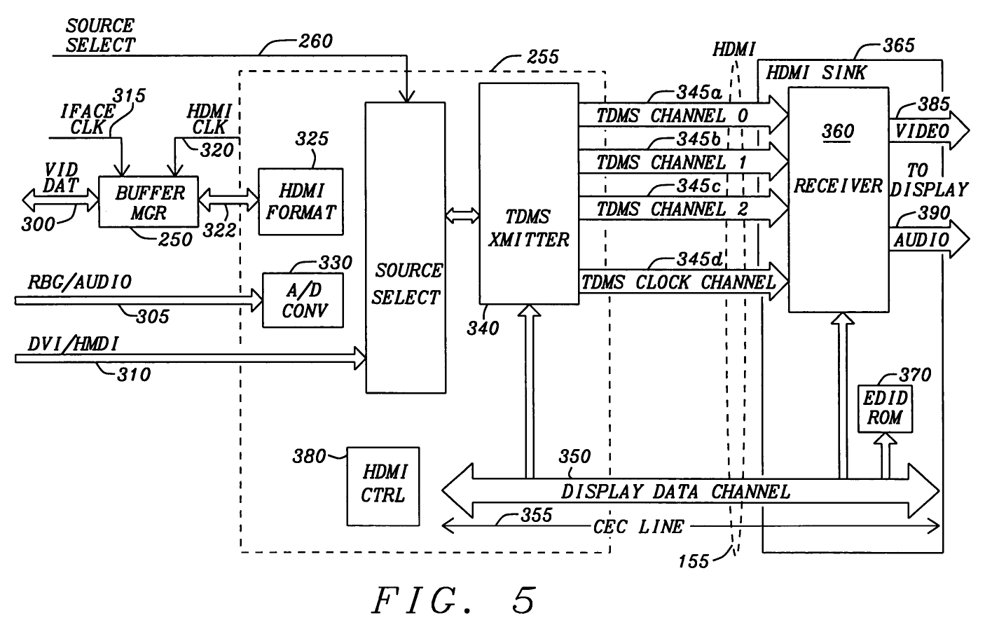

The structure and function of the HDMI interface circuit 255 is shown in FIG. 5. The video data 300 from the selected input port 202, . . . , 212 is transferred from the interface driver/receiver circuit 240 to the buffer manager 250. The buffer manager 250 acts as a simultaneous read/write two port memory circuit where the video data 300 from the selected input port 202, . . . , 212 is written to the buffer manager 250 with the interface timing clock signal 315 created from the timer circuit 225. The HDMI interface 255 creates an HDMI clock that acts as the timing signal for the reading of the video data 322 from the buffer manager 250 to the HDMI formatter 325. The HDMI formatter 325 constructs the necessary protocol and timing for the video data 325 to comply with the HDMI specification.

The red, green, blue composite video and audio signals 305 are received from the red, green, blue composite video and audio input port 216 and applied to the analog to digital converter 330 for conversion to digital video signals. These signals are then applied to the HDMI formatter 325 for conversion to video data signals that comply with the protocol and timing of the HDMI specification.

The output of the HDMI formatter 325 is the input to the source select circuit 335. The DVI/HDMI video signals 310 are received from the DVI or HDMI input port 214. Since these signals are already compliant with the HDMI specification (DVI signals are a subset of the HDMI video signals and acceptable on the cables and connectors of the HDMI specification), they are transferred directly to the source selector circuit 335. The source select signal 260 as generated by the micro control unit 220 determines the source of the video data for display. The selected video data is transferred from the source selector circuit 335 to the Transition Minimized Differential Signaling (TMDS) transmitter 335.

The Transition Minimized Differential Signaling (TMDS) transmitter 335 finalizes the conversion of the video signals to drive the HDMI cable and connectors 155 that carry the four differential pairs that make up the Transition Minimized Differential Signaling (TMDS) data and clock channels 345a, 345b, 345c, and 345d. These channels 345a, 345b, 345c, and 345d are used to carry video, audio and auxiliary data.

In addition, HDMI connectors and cable 155 carries a digital data (DDC) channel 350. The DDC 350 is used for configuration and status exchange between the HDMI interface 255 and HDMI Sink 365. The optional Consumer Electronic Control (CEC) line 355 provides high-level control functions between all of the various audiovisual products in a user's environment. The DDC 350 is used by the HDMI interface 255 to read the HDMI Sink's Enhanced Extended Display Identification Data (EDID) from the EDID read only memory 370 in order to discover the HDMI Sink's 365 configuration and/or capabilities.

The receiver 360 of the HDMI Sink 365 receives the HDMI converted video signals from the HDMI connectors and cable 155 and restores the video signals 385 and audio signals 370 for transmission to the display.

In summary, the multimedia display adapter of this invention includes a micro controller unit that executes a program process for performing a method for converting a video signal having signal levels and format compliant with multiple video transmission interface specifications to a video signal compliant with a high definition multimedia interface for display upon a video display. The plurality of video transmission interface specifications includes for example a peripheral component interconnect specification, a universal serial bus specification, a personal computer memory card specification, an advanced attachment specification, a flash memory card specification, and high performance serial bus peer-to-peer data transfer protocol specification. The method begins by providing a plurality of input ports. Each input port is in communication with source devices that transmit video signals that comply with one of the plurality of video transmission interface specifications. One of the input ports is selected to receive one of the video signals. The video signals are retained in a memory devices such as the buffer manager described above based on timing signals in compliance with the video transmission interface specification to which the video signal conforms. The retained video signal is then extracted from the memory device with a timing signal in compliance with the high definition multimedia interface specification. The video signal is then formatted to the voltage levels and protocol in compliance with the high definition multimedia interface, and transmitted to a video display.

An analog input port is in communication with at least one analog video source to accept an analog video signal. The analog video signal is received from the analog input port and converted to a digital video signal. The digitized analog signal is then formatted to the voltage levels and protocol in compliance with the high definition multimedia interface.

The HDMI formatted video signals are transferred to a transition minimized differential signaling driver. The Transition Minimized Differential Signaling (TMDS) driver then amplifies and buffers the video signal in compliance with the high definition multimedia specification for transmission to the video display.

A digital video interface port is in communication with a digital video interface video source and an HDMI interface port is in communication with an HDMI video source. The video signals are received from digital video interface port and transmitted directly to the video display.

While this invention has been particularly shown and described with reference to the preferred embodiments thereof, it will be understood by those skilled in the art that various changes in form and details may be made without departing from the spirit and scope of the invention.

The invention claimed is:

1. An interface adapter to convert a video signal having signal levels and format compliant with one of a plurality of video transmission interface specifications to a video signal compliant with a high definition multimedia interface for display upon a video display, said interface adapter comprising:
a plurality of input ports in communication with source devices whereby one source device is selected to provide said video signal and each of said input ports accept video signals that comply with one of said plurality of video transmission interface specifications;
a synchronization device in communication with the plurality of input ports for receiving and retaining said selected video signal based on timing signals in compliance with the video transmission interface specification to which said video signal conforms;
a high definition multimedia formatter in communication with said synchronization device to extract said video signal with a timing signal in compliance with said high definition multimedia interface specification, format said video signal to the voltage levels and format of the high definition multimedia interface; and
an output port to transmit said video signal in compliance with said high definition multimedia specification to a video display.

2. The interface adapter of claim 1 further comprising:
a source selector in communication with said input ports to select one of said input port to provide said video signal from one of said source devices.

3. The interface adapter of claim 2 further comprising:
an analog input port in communication with analog video sources to accept an analog video signal; and
an analog to digital converter in communication with said analog input port to receive said analog video signal and convert said analog video signal to a digital video signal and in communication with said high definition multimedia formatter to format said digitized analog video signal to the voltage levels and format of the high definition multimedia interface.

4. The interface adapter of claim 1 further comprising
a transition minimized differential signaling driver in communication with the high definition multimedia formatter to amplify and buffer said video signal in compliance with said high definition multimedia specification for transfer to said output port.

5. The interface adapter of claim 2 further comprising:
a digital video interface port in communication with a digital video interface video source to receive a digital video interface video signal for transfer to said source selector for optional selection for transfer to said output for transmission to said video display.

6. The interface adapter of claim 2 further comprising:
a high definition multimedia interface input port in communication with a high definition multimedia interface video source to receive a high definition multimedia interface video signal for transfer to said source selector for optional selection for transfer to said output for transmission to said video display.

7. The interface adapter of claim 1 wherein said plurality of video transmission interface specifications comprises a peripheral component interconnect specification, a universal serial bus specification, a personal computer memory card specification, an advanced attachment specification, a flash memory card specification, and high performance serial bus peer-to-peer data transfer protocol specification.

8. A multimedia system comprising:
a plurality of source devices whereby each source device provides a video signal that complies with one of said plurality of video transmission interface specifications;
a video display having an interface compliant with a high definition multimedia interface specification;
an interface adapter in communication with said plurality of source device to receive a selected video signal and to convert said selected video signal having signal levels and format compliant with one of the plurality of video transmission interface specifications to a video signal compliant with a high definition multimedia interface specification for transmission to and display upon the video display, said interface adapter comprising:
a plurality of input ports in communication with source devices whereby one source device is selected to provide said selected video signal and each of said input ports accept video signals that comply with one of said plurality of video transmission interface specifications;
a synchronization device in communication with the plurality of input ports for receiving and retaining said selected video signal based on timing signals in compliance with the video transmission interface specification to which said video signal conforms;
a high definition multimedia formatter in communication with said synchronization device to extract said video signal with a timing signal in compliance with said high definition multimedia interface specification, format said video signal to the voltage levels and format of the high definition multimedia interface; and
an output port to transmit said video signal in compliance with said high definition multimedia specification to a video display.

9. The multimedia system of claim 8 wherein said interface adapter comprises:
a source selector in communication with said input ports to select one of said input port to provide said video signal from one of said source devices.

10. The multimedia system of claim 9 wherein said interface adapter comprises:
an analog input port in communication with analog video sources to accept an analog video signal; and
an analog to digital converter in communication with said analog input port to receive said analog video signal and convert said analog video signal to a digital video signal and in communication with said high definition multimedia formatter to format said digitized analog video signal to the voltage levels and format of the high definition multimedia interface.

11. The multimedia system of claim 8 wherein said interface adapter comprises
a transition minimized differential signaling driver in communication with the high definition multimedia formatter to amplify and buffer said video signal in compliance with said high definition multimedia specification for transfer to said output port.

12. The multimedia system of claim 9 wherein said interface adapter comprises:
a digital video interface port in communication with a digital video interface video source to receive a digital video interface video signal for transfer to said source selector for optional selection for transfer to said output for transmission to said video display.

13. The multimedia system of claim 9 wherein said interface adapter comprises:
a high definition multimedia interface input port in communication with a high definition multimedia interface video source to receive a high definition multimedia interface video signal for transfer to said source selector for optional selection for transfer to said output for transmission to said video display.

14. The multimedia system of claim 8 wherein said plurality of video transmission interface specifications comprises a peripheral component interconnect specification, a universal serial bus specification, a personal computer memory card specification, an advanced attachment specification, a flash memory card specification, and high performance serial bus peer-to-peer data transfer protocol specification.

15. A method for converting a video signal having signal levels and format compliant with one of a plurality of video transmission interface specifications to a video signal compliant with a high definition multimedia interface for display upon a video display, said method comprising the steps of:
providing a plurality of input ports, each input port in communication with source devices that transmit video signals that comply with one of said plurality of video transmission interface specifications;
selecting one of the input ports to accept one of said video signals; receiving said video signal from said selected input port;
retaining said video signal based on timing signals in compliance with the video transmission interface specification to which said video signal conforms;
extracting said retained video signal with a timing signal in compliance with said high definition multimedia interface specification;
formatting said video signal to the voltage levels and protocol in compliance with the high definition multimedia interface; and
transmitting said video signal in compliance with said high definition multimedia specification to a video display.

16. The method of claim 15 further comprising the steps of:
providing an analog input port in communication with analog video sources to accept an analog video signal;
receiving said analog video signal from said analog input port;
converting said analog video signal to a digital video signal; and
formatting said digitized analog video signal to the voltage levels and protocol in compliance with the high definition multimedia interface.

17. The method of claim 15 further comprising the step of:
providing a transition minimized differential signaling driver to amplify and buffer said video signal in compliance with said high definition multimedia specification for transmission to said video display.

18. The method of claim 15 further comprising the steps of:
providing a digital video interface port in communication with a digital video interface video source;
receiving a digital video interface video signal from digital video interface port; and
transmitting said digital video interface video signal to the video display.

19. The method of claim 15 further comprising the steps of:
providing a high definition multimedia interface port in communication with a high definition multimedia interface video source;
receiving a high definition multimedia interface video signal from high definition multimedia interface port; and
transmitting said high definition multimedia interface video signal to the video display.

20. The method of claim 15 wherein said plurality of video transmission interface specifications comprises a peripheral component interconnect specification, a universal serial bus specification, a personal computer memory card specification, an advanced attachment specification, a flash memory card specification, and high performance serial bus peer-to-peer data transfer protocol specification.

21. An apparatus for converting a video signal having signal levels and format compliant with one of a plurality of video transmission interface specifications to a video signal compliant with a high definition multimedia interface for display upon a video display, said apparatus comprising:
means for providing a plurality of input ports, each input port in communication with source devices that transmit video signals that comply with one of said plurality of video transmission interface specifications;
means for selecting one of the input ports to accept one of said video signals;
means for receiving said video signal from said selected input port;
means for retaining said video signal based on timing signals in compliance with the video transmission interface specification to which said video signal conforms;
means for extracting said retained video signal with a timing signal in compliance with said high definition multimedia interface specification;
means for formatting said video signal to the voltage levels and protocol in compliance with the high definition multimedia interface; and
means for transmitting said video signal in compliance with said high definition multimedia specification to a video display.

22. The apparatus of claim 21 further comprising:
means for providing an analog input port in communication with analog video sources to accept an analog video signal;
means for receiving said analog video signal from said analog input port;
means for converting said analog video signal to a digital video signal; and
means for formatting said digitized analog video signal to the voltage levels and protocol in compliance with the high definition multimedia interface.

23. The apparatus of claim 21 further comprising:
means for providing a transition minimized differential signaling driver to amplify and buffer said video signal in compliance with said high definition multimedia specification for transmission to said video display.

24. The apparatus of claim 21 further comprising:
means for providing a digital video interface port in communication with a digital video interface video source;
means for receiving a digital video interface video signal from digital video interface port; and
means for transmitting said digital video interface video signal to the video display.

25. The apparatus of claim 21 further comprising:
means for providing a high definition multimedia interface port in communication with a high definition multimedia interface video source;
means for receiving a high definition multimedia interface video signal from high definition multimedia interface port; and
means for transmitting said high definition multimedia interface video signal to the video display.

26. The apparatus of claim 21 wherein said plurality of video transmission interface specifications comprises a peripheral component interconnect specification, a universal serial bus specification, a personal computer memory card specification, an advanced attachment specification, a flash memory card specification, and high performance serial bus peer-to-peer data transfer protocol specification.

27. A medium for retaining a computer program which, when executed on a computing system, performs a program process for converting a video signal having signal levels and format compliant with one of a plurality of video transmission interface specifications to a video signal compliant with a high definition multimedia interface for display upon a video display, said medium for retaining a computer program comprising the steps of:
providing a plurality of input ports, each input port in communication with source devices that transmit video signals that comply with one of said plurality of video transmission interface specifications;
selecting one of the input ports to accept one of said video signals;
receiving said video signal from said selected input port;
retaining said video signal based on timing signals in compliance with the video transmission interface specification to which said video signal conforms;
extracting said retained video signal with a timing signal in compliance with said high definition multimedia interface specification;
formatting said video signal to the voltage levels and protocol in compliance with the high definition multimedia interface; and
transmitting said video signal in compliance with said high definition multimedia specification to a video display.

28. The medium for retaining a computer program of claim 27 wherein the program process further comprises the steps of:
providing an analog input port in communication with analog video sources to accept an analog video signal;
receive said analog video signal from said analog input port;
converting said analog video signal to a digital video signal; and
formatting said digitized analog video signal to the voltage levels and protocol in compliance with the high definition multimedia interface.

29. The medium for retaining a computer program of claim 27 wherein the program process further comprises the step of:
providing a transition minimized differential signaling driver to amplify and buffer said video signal in compliance with said high definition multimedia specification for transmission to said video display.

30. The medium for retaining a computer program of claim 27 wherein the program process further comprises the steps of:
providing a digital video interface port in communication with a digital video interface video source;
receiving a digital video interface video signal from digital video interface port; and
transmitting said digital video interface video signal to the video display.

31. The medium for retaining a computer program of claim 27 wherein the program process further comprises the steps of:
providing a high definition multimedia interface port in communication with a high definition multimedia interface video source;
receiving a high definition multimedia interface video signal from high definition multimedia interface port; and
transmitting said high definition multimedia interface video signal to the video display.

32. The medium for retaining a computer program of claim 27 wherein said plurality of video transmission interface specifications comprises a peripheral component interconnect specification, a universal serial bus specification, a personal computer memory card specification, an advanced attachment specification, a flash memory card specification, and high performance serial bus peer-to-peer data transfer protocol specification.
